(19) United States
(12) Patent Application Publication
(10) Pub. No.: US 2003/0030554 A1
(43) Pub. Date: Feb. 13, 2003

(54) Vehicle rear speed display

(76) Inventor: Edward Q. Yavitz, Rockford, IL (US)

Correspondence Address: Robert A. Van Someren, Fletcher, Yodre & Van Someren, P.O. Box 692289, Houston, TX, 77269-2289, US

(21) Appl. No.: 09/928,156

(22) Filed: Aug. 10, 2001

(51) Int. Cl. B60Q 1/22; B60Q 1/00

(52) U.S. Cl. 340/466; 340/463

(57) ABSTRACT

A technique to improve traffic flow by indicating a rate of deceleration or acceleration to a following driver. The technique utilizes a display configured to be mounted on a vehicle and to indicate the speed of the vehicle to following drivers. The display may be visible to a driver of the vehicle when viewed through the rear view mirror. A speed controller may be used for changing the speed of a following vehicle based upon the speed of the lead vehicle.

### FIELD OF THE INVENTION

The present invention relates generally to the regulation and improvement of traffic flow, and more particularly, to indicating to drivers the rate of acceleration or deceleration of the vehicle in front of them.

### BACKGROUND OF THE INVENTION

Traffic flow is important to the economy and prosperity of any major metropolitan area. Highways are designed to allow vehicles to freely travel virtually anywhere at any time. However, cities in America are increasingly seeing shortages of highway capacity due to increased numbers of vehicles. These shortages are costing vehicle drivers both health and money. Traffic congestion costs taxpayers $78 billion a year and has been linked to high blood pressure, sleep deprivation, and depression. The average American wastes almost a full workweek sitting in traffic each year.

Modern highways could have greatly increased efficiency of flow if, for example, vehicles could maintain movement at up to sixty miles per hour with less than a car length between each vehicle for measurable lengths of time. In reality, however, the same group of cars can slow to a halt within a minute due to a variety of restrictions and driver responses. One interruption to efficient flow occurs when a following vehicle travels behind a lead vehicle, which slows for a restriction of some sort. The following vehicle's driver, seeing the brake lights of the lead vehicle, immediately responds by applying the brakes. The following driver tends to overcompensate to ensure a minimum distance from the lead vehicle and to avoid an accident. The vehicle behind the following vehicle then does likewise resulting in a chain of vehicles each of which is decelerating more than the vehicle in front of it. Ultimately, one of the vehicles stops.

With heavier traffic, the scenario is common. Slight obstructions can cause extreme reductions in traffic flow. Traffic expands and contracts in accordion-like fashion around the area of such an obstruction even hours after the obstruction is cleared and for miles from the actual site of the obstruction.

The continued congestion long after an obstruction is cleared has been referred to as an invisible traffic jam. The phenomenon is caused by drivers, inability to accurately estimate the deceleration and acceleration rates of cars in front of them. This inability causes overcompensation when a lead vehicle applies its brakes resulting in a sequence of progressively slower moving cars until traffic comes to a complete halt.

Eaton Corporation has patented a deceleration warning system for trucks which involves using a radar sensor on the front of the truck which sets off an alarm when the closing rate of the truck upon the vehicle ahead becomes dangerous. However, radar is expensive and does not work in situations where the vehicle ahead is not directly aligned with the truck or car so equipped. For example, curves or even fixed metal objects on the side of the road pose problems for radar. Other possible signaling devices have the same inherent flaws as radar systems when it comes to curves in the road or stray signals from vehicles ahead but in a different lane.

### SUMMARY OF THE INVENTION

The present invention relates generally to a technique for displaying the speed of a vehicle to an observer behind the vehicle and, in some embodiments, to the driver of the vehicle. In another embodiment, a method is provided for preventing traffic jams, the method comprising displaying a vehicle's speed to a following driver. Another embodiment of the present invention comprises displaying the speed of a vehicle to a following vehicle, wherein the following vehicle uses an apparatus for sensing the speed displayed by the lead vehicle and displaying it for the following driver. Still another embodiment of the present invention comprises linking the speed sensing device with a speed controller in a vehicle so the speed controller automatically adjusts the speed of the following vehicle based upon the displayed speed of the lead vehicle.

### BRIEF DESCRIPTION OF THE DRAWINGS

The invention will hereafter be described with reference to the accompanying drawings wherein like reference numerals denote like elements, and:

FIG. 1 is a side view of vehicles in a typical traffic situation;

FIG. 2 is a side view of vehicles in a typical traffic situation, the lead vehicle having a rear speed indicator;

FIG. 3 is a diagram of the electrical or mechanical connections of the rear speed indicator;

FIG. 4 is a rear view of a vehicle having a rear speed indicator;

FIG. 5 is a rear view of a vehicle having an alternate embodiment indicator comprising a heads-up display rear speed indicator;

FIG. 6 is a side view illustrating the orientation of the rear speed indicator with respect to the first and second drivers;

FIG. 7 is a side view of vehicles in traffic, the following vehicle having another embodiment of the present invention for sensing and displaying the speed of the lead vehicle within the following vehicle;

FIG. 8 is a view from inside the following vehicle showing another alternate embodiment of the invention where the rear speed indicator of the lead vehicle is sensed by the following vehicle and displayed within the following vehicle in heads-up format on the front windshield; and

FIG. 9 is a diagram of an alternate embodiment of the invention utilizing an automated control system.

### DETAILED DESCRIPTION OF EXEMPLARY EMBODIMENTS

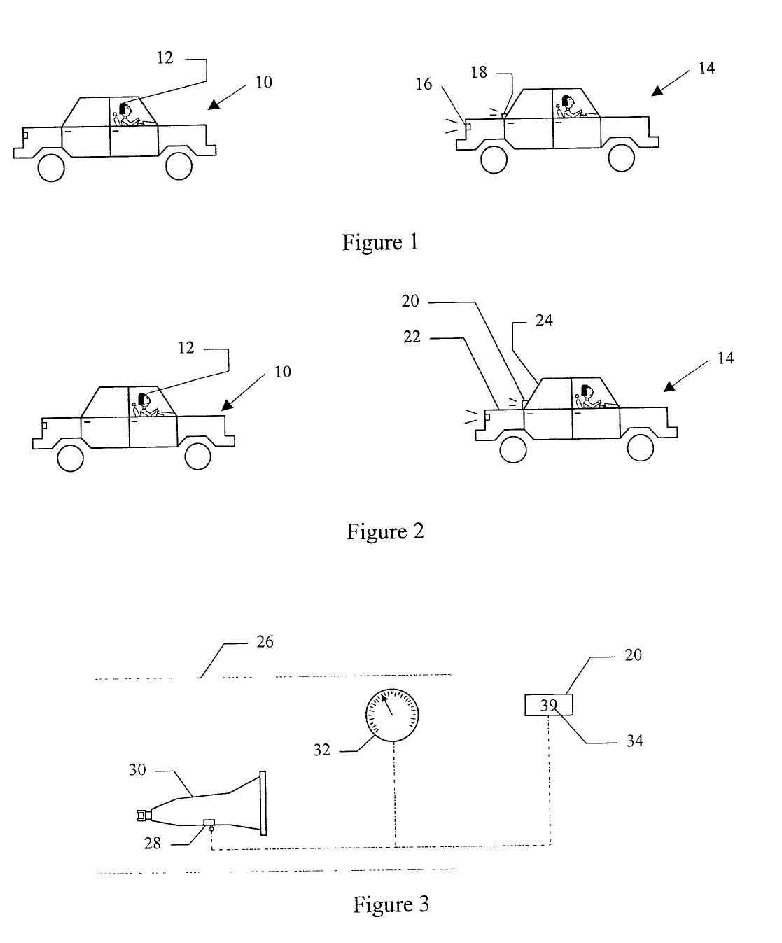

Referring generally to FIG. 1, a typical traffic situation is illustrated. A following vehicle 10, driven by a driver 12, is shown following a lead vehicle 14. The driver 12 may be referred to as the following driver. As is common in traffic situations, the lead vehicle 14 is decelerating for any of various reasons including debris in the road, a traffic accident ahead, or a slowing vehicle in front of the lead vehicle 14. In assessing the deceleration of the lead vehicle 14, the following driver 12 commonly has difficulty estimating the exact speed of the lead vehicle 14 and has difficulty determining the amount of deceleration needed for the following vehicle 10 to avoid getting any closer to the lead vehicle 14. Also, the following driver's 12 situation is worsened by following the lead vehicle 14 too closely, which allows little reaction time.

The difficulty with estimating the lead vehicle's 14 deceleration rate and the short reaction time generally result in overcompensation by the following driver 12. Brake lights 16 help prevent accidents by indicating to the following driver 12 that the lead vehicle 14 is decelerating. However, brake lights 16 do not indicate the rate of the lead vehicle's 14 deceleration. The newer generation of elevated brake lights 18 mounted in the rear window of most vehicles are more visible than the older brake lights 16; however, they do not help the following driver 12 estimate the rate of deceleration of the lead vehicle 14.

An exemplary embodiment of the present invention provides the indication that the following driver 12 needs to estimate the rate of deceleration of the lead vehicle 14. With reference to FIG. 2, the exemplary embodiment is illustrated on the lead vehicle 14. The lead vehicle 14 has a rear speed indicator 20. The rear speed indicator 20 is mounted proximate the trunk 22, for instance, and extends upward covering a portion of the rear windshield 24. In the exemplary embodiment, the rear speed indicator 20 displays the speed of the lead vehicle 14 in alphanumeric format to the following driver 12. The following driver 12 is able to see the speed of the lead vehicle 14 as indicated on the rear speed indicator 20 and to adjust the speed of the following vehicle 10 accordingly.

The rear speed indicator 20 displays the speed of the lead vehicle 14 in alphanumeric format. However, a graphical format, or other formats that convey the actual numerical speed or the speed relative to a predetermined value may be used. The rear speed indicator 20 may comprise an analog gauge, a digital display, a series of lights, or any other display or indicator that shows an actual or relative speed.

The rear speed indicator 20 may also comprise a transparent display such that it is visible both to the following driver 12 and to a driver of the lead vehicle. The driver of the lead vehicle is able to view the display as reflected through a rear view mirror. This aspect will be discussed in more detail below.

Referring to FIG. 3, the rear speed indicator 20 may utilize a speedometer 26. The speedometer 26, as is well known to a person having ordinary skill in the art and required by law in the United States, comprises a speed sensor 28 located, for example, in the transmission 30 of a vehicle. The rear speed indicator 20 may use a speed sensor 28 that is associated with other vehicle equipment besides speedometer 26, or it may use its own dedicated speed sensor 28. Speed sensor 28 of the speedometer 26 is used only as an example. The speed sensor 28 is electrically or mechanically coupled to a display 32, which may comprise an analog gauge, a digital display, or a heads-up display (see FIG. 3). The components and operation of the speedometer 26 are well known to a person having ordinary skill in the art.

The rear speed indicator 20 may be electrically or mechanically coupled to the speed sensor 28 as illustrated in FIG. 3. The rear speed indicator 20 converts the electrical or mechanical signal from the speed sensor 28 into a readout 34 as shown on the rear speed indicator 20. The conversion may be accomplished according to a variety of techniques known to those of ordinary skill in the art.

Readout 34 allows the following driver 12 to adjust the speed of the following vehicle 10 without overcompensating. The effects of overcompensation, then, are not passed from vehicle to vehicle in dense traffic situations that would otherwise ultimately result in an invisible traffic jam. The rear speed indicator 20 helps alleviate invisible traffic jams, which constitute a substantial portion of traffic problems in major urban areas.

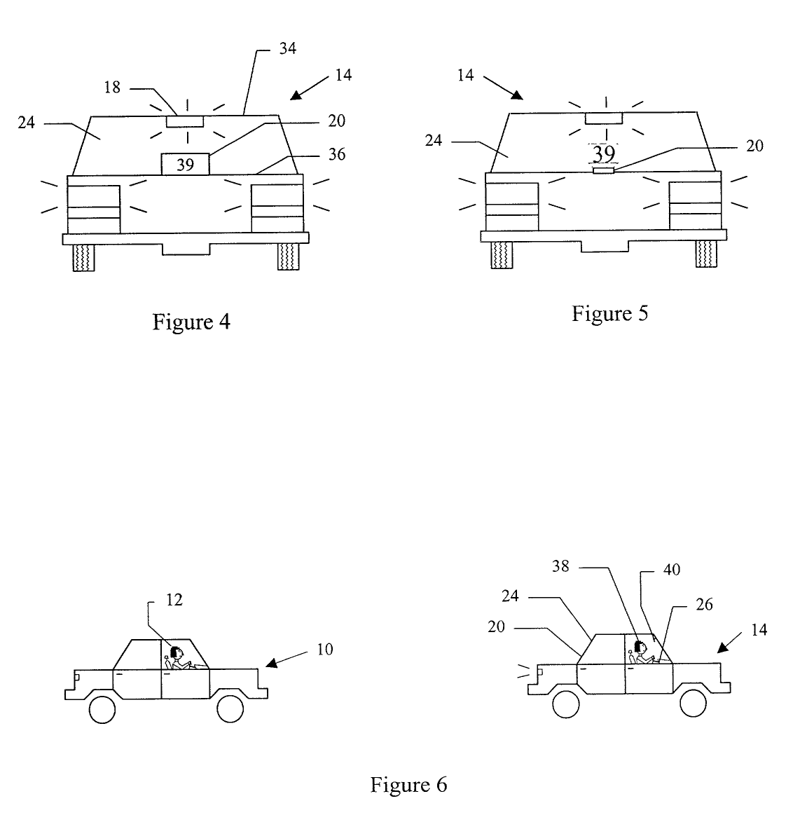

As illustrated in FIG. 4, the rear speed indicator 20 may replace the elevated brake light 18, or it may be combined with the elevated brake light 18. The elevated brake light 18 may be moved to the top 34 of the rear windshield 24 to allow the rear speed indicator 20 to be located at the bottom 36 of the rear windshield 24. Alternatively, the brake light 18 may remain at the bottom 36, and the rear speed indicator 20 may be located at the top 34. However, the invention is not limited to these arrangements. The rear speed indicator 20 may be placed on the trunk 22 (see FIG. 2), on the rear portion of the lead vehicle 14, or anywhere on the lead vehicle 14 such that it can be seen by the following driver 12 (see FIG. 2).

As shown in FIG. 5, the rear speed indicator 20 may take the form of a “heads-up” display. Heads-up displays are commonly used in vehicles to indicate speed or other parameters on the front windshield such that they are viewable by a driver. The rear speed indicator 20 may comprise a heads-up display projected on the rear windshield 24 such that the speed of the lead vehicle 14 is displayed on the rear windshield 24 of the lead vehicle 14. When the rear speed indicator 20 utilizes this embodiment, the following driver 12 (see FIG. 2) is able to see the speed of the lead vehicle 14 displayed in the rear windshield 24.

With reference to FIG. 6, when the lead driver 38 looks in the rear-view mirror 40, the lead driver 38 has an unobstructed view through the rear windshield 24 while receiving an indication of the speed of his or her own vehicle without looking down at the speedometer 26. When the speed is displayed in the rear windshield 24 in the proper form for viewing by the following driver 12, the rear-view mirror provides a mirror image for the lead driver 38. This arrangement allows the lead driver 38 to see his speed in its proper orientation by simply looking at the rear-view mirror 40 without taking his eyes off the road.

The technique is not limited to speed. Other information may be displayed using the technique, such as fuel remaining, low fuel warning, odometer or trip meter, or a variety of other measurements or warnings. The information can be displayed on the rear windshield 24 in the same manner as the speed such that when viewed through the rear view mirror 40, it is properly oriented for viewing by the lead driver 38.

The rear speed indicator 20 does not have to take the form of a heads-up display to be viewed by the lead driver 38 through the rear view mirror 40. Other types of transparent display would allow the speed or other information to be seen both by the lead driver 38 and by the following driver 12. The information is properly oriented for viewing by the lead driver 38 when reflected through the rear view mirror 40.

Display in this manner allows the lead driver 38 to keep his eyes on the road while monitoring automobile parameters. The lead driver 38 does not have to look down at the gauges and indicators in the dash periodically. Even more importantly, a warning indicator displayed such that it can be viewed through the rear view mirror 40 is more likely to catch the lead driver's 38 attention.

Furthermore, with the speed of every vehicle readily observable from the side of a highway, law enforcement can easily identify those vehicles exceeding the speed limit and take appropriate action. In an alternate embodiment, the speed is not displayed in the rear speed indicator 20 until the lead vehicle 14 is traveling either below or above some predetermined speed or until the brakes are applied in the lead vehicle 14. In the latter situation, the rear speed indicator 20 displays the speed when the brake lights 16, 18 are illuminated.

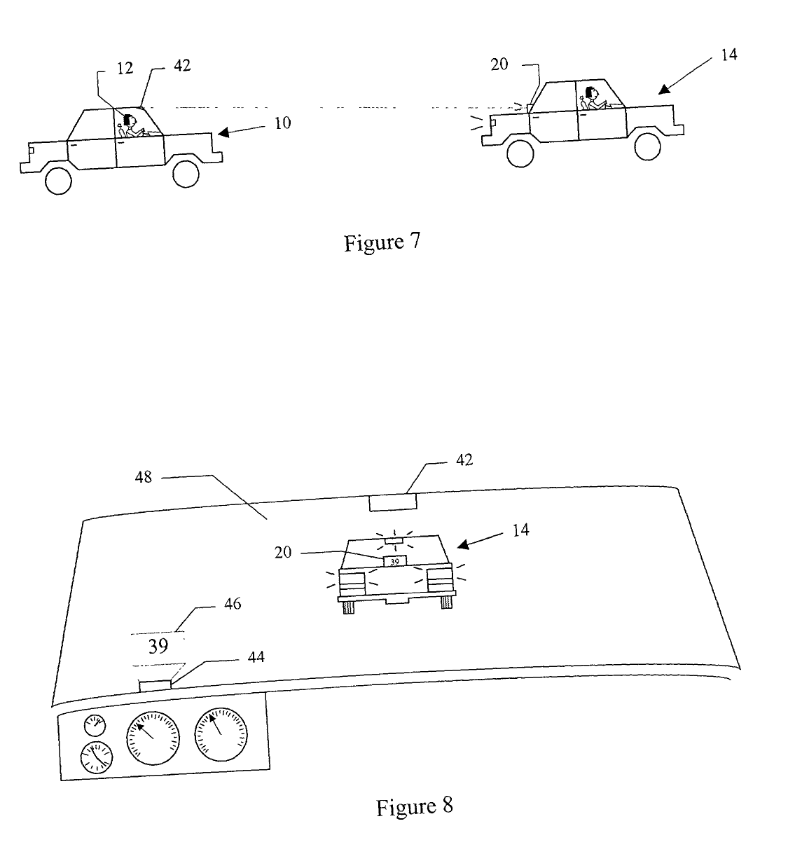

With reference to FIGS. 7 and 8, another alternate embodiment of the present invention replaces the requirement that the following driver 12 see the rear speed indicator 20 on the lead vehicle 14. A sensing apparatus 42 is mounted on the following vehicle 10 for sensing the speed shown on the rear speed indicator 20 located on the lead vehicle 14. The sensing apparatus 42 transmits the speed to a display apparatus 44 within the following vehicle 10 (see FIG. 8). As shown in FIG. 8, the display apparatus 44 may be a gauge type display, a digital display, or a heads-up display 46 projected on the front windshield 48 of the following vehicle 10.

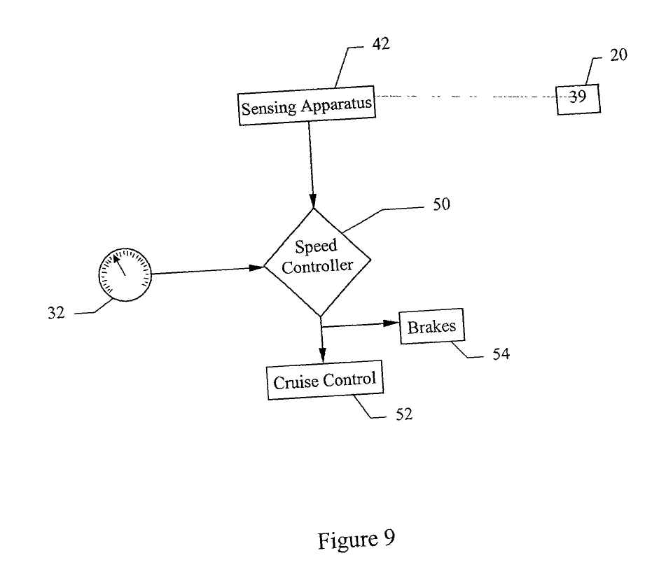

With reference to FIG. 9, a further alternate embodiment of the present invention comprises linking the sensing apparatus 42 to a speed controller 50. The speed controller 50 may obtain the speed of the following vehicle 10 from the speedometer 32 of the following vehicle 10. Alternatively, the speed controller 50 may obtain the speed of the following vehicle 10 from a speed sensor 28 as described above with reference to FIG. 3. The speed controller 50 compares the speeds of the following vehicle 10 (see FIG. 7) and the lead vehicle 14 (see FIG. 7) and automatically adjusts the speed of the following vehicle 10 based upon the comparison. Adjustment may be made through the cruise control system 52 of the following vehicle 10 or by applying the brakes 54 of the following vehicle 10 for more rapid deceleration.

The speed controller 50 may contain certain criteria for evaluating differences in the speeds of the following vehicle 10 and the lead vehicle 14. For example, the speed controller 50 may be set to only adjust the speed of the following vehicle 10 if the difference is greater than some arbitrary quantity. Alternatively, the speed controller 50 may be simply set to increase the speed of the following vehicle 10 if the difference is positive and to decrease the speed of the following vehicle 10 if the difference is negative.

It will be understood that the foregoing description is of exemplary embodiments of this invention, and that the invention is not limited to the specific form shown. For example, the rear speed indicator may be mounted in a variety of locations on a vehicle such as on the rear bumper, on the trunk lid, on the rear windshield, or anywhere on the rear of the vehicle. The procedural steps discussed above for preventing traffic congestion may be altered depending on the amount of automation desired. For example, the response of the following vehicle may be manual or automated. These and other modifications in the design and arrangement of the elements may be made without departing from the scope of the invention as expressed in the dependent claims.

What is claimed is:

1. A vehicle speed display, comprising a display device electrically coupled to a speed sensor mounted on a vehicle, the display device being configured to display a speed of the vehicle to a first driver located behind the vehicle.

2. The vehicle speed display of claim 1 wherein the display device comprises an alphanumeric display.

3. The vehicle speed display of claim 1 wherein the display device comprises a heads-up display projected on the rear windshield of the vehicle.

4. The vehicle speed display of claim 1 wherein the display device comprises a graphical display.

5. The vehicle speed display of claim 1 wherein the display device is mounted on the rear windshield.

6. The vehicle speed display of claim 1 wherein the display device is mounted on a trunk of the vehicle.

7. The vehicle speed display of claim 1 wherein the display device is further configured to display the speed of the vehicle to a second driver located in the vehicle.

8. A system for warning automotive drivers of changes in speed undergone by a leading vehicle, comprising:
a speed indicator designed to be mounted on the leading vehicle and configured to measure a speed of the leading vehicle, wherein the speed indicator indicates the speed for viewing outside of and behind the vehicle.

9. The system of claim 8, wherein the speed indicator comprises a speed sensor mounted on the leading vehicle and configured to measure the speed of the leading vehicle.

10. The system of claim 8, wherein the speed indicator comprises an alphanumeric display.

11. The system of claim 8, wherein the speed indicator further indicates the speed for viewing by a driver of the leading vehicle through a rear view mirror of the leading vehicle.

12. The system of claim 11, wherein the speed indicator comprises a display projected on a rear windshield of the leading vehicle.

13. The system of claim 11, wherein the speed indicator is designed to be mounted on a rear windshield of the leading vehicle.

14. A warning system, comprising:
a first vehicle comprising a speed sensor mounted on the first vehicle and configured to sense a speed of the first vehicle; and
an alphanumeric indicator mounted on the first vehicle, the alphanumeric indicator being electrically coupled to the speed sensor and configured to warn a second vehicle of the first vehicle's change in speed when the second vehicle is located behind the first vehicle.

15. The warning system of claim 14, wherein the alphanumeric indicator is mounted on the trunk of the first vehicle.

16. The warning system of claim 14, wherein the alphanumeric indicator is configured to indicate the speed of the first vehicle in alphanumeric format to the second vehicle.

17. The warning system of claim 16, wherein the alphanumeric indicator is further configured to indicate the speed of the first vehicle in alphanumeric format to a driver of the first vehicle when viewed through a rear view mirror of the first vehicle.

18. The warning system of claim 14, wherein the alphanumeric indicator is configured to indicate the speed of the first vehicle to a second vehicle when brake lights of the first vehicle are illuminated.

19. The warning system of claim 14, wherein the alphanumeric indicator is configured to display the speed of the first vehicle when the speed is below a predetermined quantity.

20. The warning system of claim 14, wherein the alphanumeric indicator comprises a digital display.

21. A method for alerting a following driver of a rate of deceleration, the method comprising the act of communicating a speed of a vehicle to the following driver in alphanumeric format with a display mounted on the vehicle.

22. The method of claim 21, wherein the act of communicating a speed comprises displaying the speed numerically for viewing outside of and behind the vehicle.

23. The method of claim 22, wherein the act of communicating a speed further comprises displaying the speed numerically for viewing by a driver of the vehicle when the display is viewed through a rear view mirror of the vehicle.

24. The method of claim 21, wherein the act of communicating a speed comprises indicating the speed when brakes of the vehicle are applied.

25. The method of claim 21, further comprising mounting the alphanumeric display on a rear portion of the vehicle.

26. A speed control system comprising:
a following vehicle comprising a speedometer configured to measure a speed of the following vehicle;
a sensing apparatus mounted on the following vehicle, wherein the sensing apparatus is configured to sense a speed of a lead vehicle, the lead vehicle being located in front of the following vehicle and comprising a speed indicator that indicates the speed of the lead vehicle to the sensing apparatus; and
a speed controller mounted on the following vehicle, electrically connected to the sensing apparatus and the speedometer, and configured to compare the speeds of the lead and following vehicles and automatically change the speed of the following vehicle based upon one or more criteria for comparing the speeds of the lead and following vehicles.

27. The speed control system of claim 26, wherein the following vehicle further comprises brakes and a cruise control, the brakes and the cruise control being connected to the speed controller for actuation by the speed controller.

28. The speed control system of claim 26, wherein the speed indicator of the lead vehicle indicates the speed of the lead vehicle to the sensing apparatus in alphanumeric format.

29. The speed control system of claim 28, wherein the speed indicator of the lead vehicle further indicates the speed of the lead vehicle to a driver of the lead vehicle when viewed through the rear view mirror.
